(19) United States
(12) Patent Application Publication
(10) Pub. No.: US 2021/0391654 A1
(43) Pub. Date: Dec. 16, 2021

(54) ANTENNA DEVICE AND RADAR SYSTEM

(71) Applicant: SONY SEMICONDUCTOR SOLUTIONS CORPORATION, Atsugi-shi, Kanagawa (JP)

(72) Inventors: Takahiro TAKEDA, Kanagawa (JP); Kenihi KAWASAKI, Kanagawa (JP)

(21) Appl. No.: 17/290,872

(22) PCT Filed: Aug. 19, 2019
(86) PCT No.: PCT/JP2019/032245

§ 371 Date: May 3, 2021

(30) Foreign Application Priority Data
Nov. 13, 2018 (JP) 2018-212646

(51) Int. Cl. H01Q 21/00; H01Q 21/24; H01Q 3/36; G01S 7/03

(52) U.S. Cl. CPC H01Q 21/0075; G01S 7/03; H01Q 3/36; H01Q 21/24

(57) ABSTRACT

Resolutions in two-dimensional directions and characteristics of beam sweeping in an antenna having directivity are improved.

A plurality of antenna elements is arranged in a two-dimensional plane. First and second feeder lines are lines for feeding power to the plurality of antenna elements from first and second directions different from each other. Directivity changes by switching the feeding directions. Furthermore, the first and second feeder lines may each include a plurality of feed lines. Directivity changes by feeding power to the plurality of feed lines with different phases from each other.

### TECHNICAL FIELD

The present technology relates to an antenna device. More specifically, the present invention relates to an antenna device having a plurality of antenna elements and a radar system using the antenna device.

### BACKGROUND ART

Conventionally, a device in which a plurality of antenna elements is arranged has been known. For example, a device has been proposed that uses a reception antenna in a two-dimensional array in which a plurality of antenna element groups, each including a plurality of vertically arranged antenna elements fed in series, is arranged in a horizontal direction, and a transmission antenna in which two such antenna element groups are arranged vertically and are switchable (see, for example, Patent Document 1).

### CITATION LIST

### Patent Document

Patent Document 1: Japanese Patent Application Laid-Open No. 2017-215328

### SUMMARY OF THE INVENTION

### Problems to be Solved by the Invention

In the above-mentioned conventional technique, a main beam is scanned (swept) in two dimensions by independently adjusting the phases of the antenna elements arranged in two dimensions. However, in this conventional technique, a resolution and a beam sweep range in the vertical direction are smaller than those in the horizontal direction, and it is necessary to increase the number of antennas in the vertical direction in order to improve characteristics in the vertical direction, which has a risk of leading to enlargement of the device.

The present technology has been made in view of such situation, and it is an object thereof to improve resolutions and characteristics of beam sweeping in two-dimensional directions in an antenna having directivity.

### Solutions to Problems

The present technology has been made to solve the above-mentioned problems, and a first aspect thereof is an antenna device including a plurality of antenna elements arranged in a two-dimensional plane, and first and second feeder lines that feed power to the plurality of antenna elements from first and second directions different from each other. Thus, by feeding power to the plurality of antenna elements from first and second directions different from each other, an operation of improving resolutions in both directions is achieved.

Furthermore, in the first aspect, the plurality of antenna elements and the first and second feeder lines may be coupled by electromagnetic field coupling. Thus, an operation of coupling the plurality of antenna elements and the first and second feeder lines as needed is achieved.

Furthermore, in this first aspect, a switching unit that switches a signal to at least one of the first or second feeder lines may be further included. Thus, an operation of feeding power to the first and second feeder lines while switching between them is achieved.

Furthermore, in the first aspect, the first and second feeder lines may each include a plurality of feed lines. Thus, an operation of feeding power to the plurality of antenna elements at the same time is achieved.

Furthermore, in the first aspect, a phase shifter that controls phases of signals of the plurality of feed lines may be further provided. In this case, the phase shifter may cause the phases of the signals of the plurality of feed lines to be all same, or to be different from each other. In the latter case, an operation of performing beam scanning without moving the antenna itself is achieved.

Furthermore, in this first aspect, the first and second feeder lines may or may not be orthogonal to each other. In a case where the first and second feeder lines are orthogonal, simultaneous vertical and horizontal feedings are possible without interference. On the other hand, in a case where the first and second feeder lines are not orthogonal to each other, an operation of improving the degree of freedom of two-dimensional mapping is achieved.

Furthermore, in the first aspect, a shape of each of the plurality of antenna elements may be a polygon having sides orthogonal to the first and second feeder lines, or a circular shape or a cross shape.

Furthermore, in the first aspect, the plurality of antenna elements may include a plurality of antenna element groups arranged in a feeding direction, and in the plurality of antenna element groups, a width of an antenna element arranged on a center side may be wider than widths of antenna elements arranged on both end sides in the feeding direction. Thus, an operation of reducing side lobes is achieved.

Furthermore, in the first aspect, the plurality of antenna elements may include a plurality of antenna element groups arranged in a feeding direction, and adjacent antenna element groups among the plurality of antenna element groups may be arranged at different positions from each other in the feeding direction. Thus, an operation of performing beam scanning without moving the antenna itself is achieved.

Furthermore, a second aspect of the present technology is a radar system including a plurality of antenna devices each including a plurality of antenna elements arranged in a two-dimensional plane, and first and second feeder lines that feed power to the plurality of antenna elements from first and second directions different from each other and that each include a plurality of feed lines, a plurality of phase shifters connected to at least one of the first or second feeder lines for each of the plurality of antenna devices to control phases of signals of the plurality of feed lines, and a communication unit that performs transmission via one of the plurality of phase shifters and reception via another of the plurality of phase shifters to acquire information regarding an object. Thus, operations of feeding power to the plurality of antenna elements from first and second directions different from each other, improving the resolutions in both directions, and acquiring information regarding an object are achieved.

Furthermore, in the second aspect, a plurality of switching units that switches, for each of the plurality of antenna devices, between the phase shifters and at least one of the first or second feeder lines may be further included, in which the plurality of switching units may perform same switchings in synchronization with each other. Thus, an operation of performing synchronized communication in transmission and reception is achieved.

Furthermore, in the second aspect, a signal processing unit that combines the acquired information to generate a position of the object may be further included. Thus, an operation of acquiring more accurate information by combining information obtained by beam scanning of the antenna and information obtained by the radar is achieved.

### BRIEF DESCRIPTION OF DRAWINGS

FIG. 1 is a diagram illustrating an example of an overall configuration of a radar system in a first embodiment of the present technology.

FIG. 2 is a diagram illustrating an example of a configuration of a communication apparatus 300 in the first embodiment of the present technology.

FIG. 3 is a diagram illustrating an example of a structure of an antenna 100 in the first embodiment of the present technology.

FIG. 4 is a diagram illustrating an example of feeding directions of the antenna 100 in the first embodiment of the present technology.

FIG. 5 is a diagram illustrating an example of characteristics of the antenna 100 by vertical feeding in the first embodiment of the present technology.

FIG. 6 is a diagram illustrating an example of characteristics of the antenna 100 by horizontal feeding in the first embodiment of the present technology.

FIG. 7 is a diagram illustrating an example of phases of respective ports of feeder lines 150 in a second embodiment of the present technology.

FIG. 8 is a diagram illustrating an example of characteristics of an antenna 100 by vertical feeding in the second embodiment of the present technology.

FIG. 9 is a diagram illustrating an example of characteristics of the antenna 100 by horizontal feeding in the second embodiment of the present technology.

FIG. 10 is a diagram illustrating an example of an overall configuration of a radar system in a third embodiment of the present technology.

FIG. 11 is a diagram illustrating a specific example of determining a position of an object in the third embodiment of the present technology.

FIG. 12 is a diagram illustrating an example of an overall configuration of a radar system in a fourth embodiment of the present technology.

FIG. 13 is a diagram illustrating a first shape example of an antenna 100 in a fifth embodiment of the present technology.

FIG. 14 is a diagram illustrating a second shape example of the antenna 100 in the fifth embodiment of the present technology.

FIG. 15 is a diagram illustrating a third shape example of the antenna 100 in the fifth embodiment of the present technology.

FIG. 16 is a diagram illustrating an arrangement example of antenna elements 110 of an antenna 100 in a sixth embodiment of the present technology.

FIG. 17 is a diagram illustrating an example of object detection in the sixth embodiment of the present technology.

### MODE FOR CARRYING OUT THE INVENTION

Hereinafter, modes for carrying out the present technology (hereinafter referred to as embodiments) will be described. The description will be given in the following order.

1. First embodiment (example of feeding power from different directions)

2. Second embodiment (example of feeding power with phase shift)

3. Third embodiment (example of combining radar information)

4. Fourth embodiment (example of simultaneous feedings)

5. Fifth embodiment (variation example of shape of antenna element)

6. Sixth embodiment (example of shifted arrangement of antennas)

### 1. First Embodiment

### [Configuration]

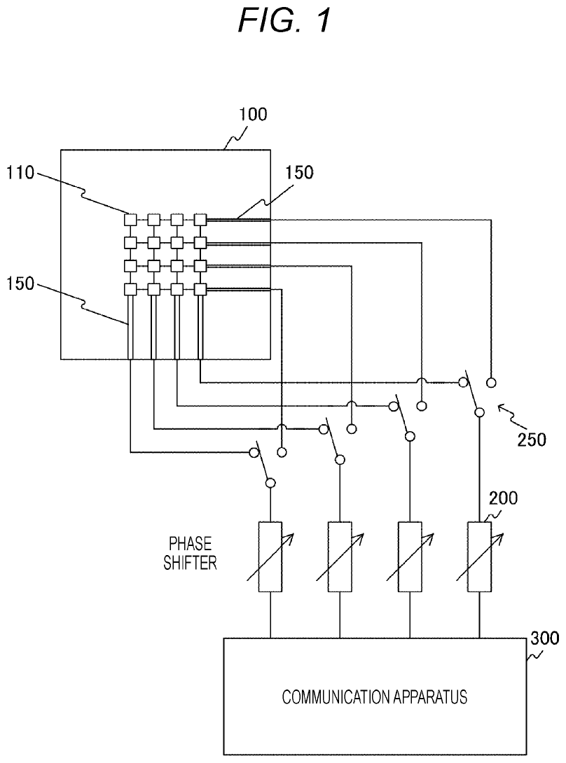

FIG. 1 is a diagram illustrating an example of an overall configuration of a radar system in a first embodiment of the present technology.

This radar system includes an antenna 100, a phase shifter 200, a switching unit 250, and a communication apparatus 300.

The antenna 100 includes a plurality of antenna elements 110 and a plurality of feeder lines 150. The plurality of antenna elements 110 is arranged two-dimensionally. In this example, a total of sixteen antenna elements 110, four in a horizontal direction (row direction) and four in a vertical direction (column direction), are arranged in an array to form a two-dimensional antenna array.

The plurality of antenna elements 110 has a configuration in which power can be fed from different directions by the plurality of feeder lines 150. In this example, feeder lines for feeding power in the vertical direction from a lower side and feeder lines for feeding power in the horizontal direction from a right side are provided. That is, the plurality of feeder lines 150 includes feeder lines orthogonal to each other. Note that the plurality of feeder lines 150 is an example of first and second feeder lines described in the claims.

Note that in this example, the shapes of the antenna elements 110 are assumed to be a square, but as will be described later, other shapes such as a polygon or a circular shape may be used.

Each of the plurality of feeder lines 150 includes a plurality of feed lines according to the number of the plurality of antenna elements 110. In this example, four feed lines that feed power in the vertical direction from the lower side and four feed lines that feed power in the horizontal direction from the right side are provided.

The phase shifter 200 is a phase switch that controls the phase when power is fed to the antenna elements 110. The phase shifter 200 is provided corresponding to each of the feed lines in the feeder lines 150. In this example, four phase shifters 200 are provided corresponding to the four feed lines. Furthermore, in the first embodiment, it is assumed that the four phase shifters 200 feed power with the same phases.

The switching unit 250 switches the connection between the phase shifter 200 and the plurality of feeder lines 150. Here, as the switching unit 250, for example, a high frequency (radio frequency (RF)) switch such as micro electro mechanical systems (MEMS) is assumed. The switching unit 250 is for connecting one phase shifter 200 to either a feed line in the vertical direction or a feed line in the horizontal direction.

The communication apparatus 300 is a device that connects to the antenna 100 via the phase shifter 200 to perform transmission and reception. This communication apparatus 300 is assumed to be a radar apparatus that transmits radio waves such as millimeter waves toward an object, receives reflected waves thereof, and measures the distance to the object by a time difference. In this case, it is common to provide a transmission antenna and a reception antenna separately. Therefore, two types of the antenna 100 are provided, a transmitting antenna and a receiving antenna. Furthermore, in that case, the switching units 250 of the transmitting antenna and the receiving antenna perform the same switching in synchronization with each other.

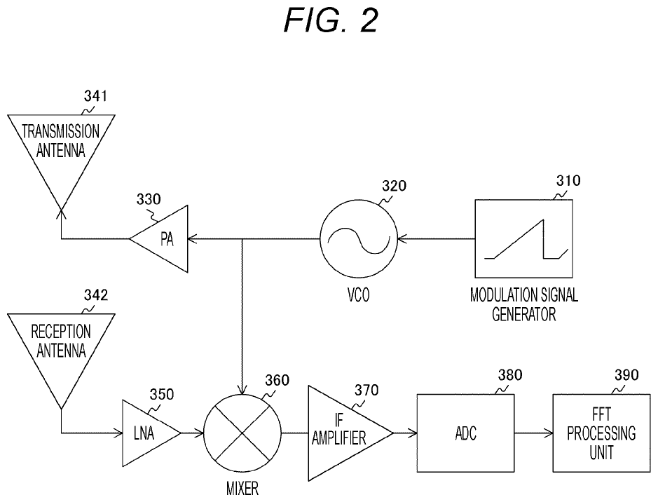

FIG. 2 is a diagram illustrating an example of a configuration of the communication apparatus 300 in the first embodiment of the present technology.

The communication apparatus 300 includes a modulated signal generator 310, a voltage controlled oscillator 320, a power amplifier 330, a transmission antenna 341, a reception antenna 342, a low noise amplifier 350, a frequency mixer 360, an intermediate frequency amplifier 370, an analog-to-digital converter 380, and an FFT processing unit 390. The transmission antenna 341 and the reception antenna 342 correspond to the antenna 100 of this embodiment.

The modulated signal generator 310 generates a modulated signal obtained by modulating a carrier wave to be transmitted. The voltage controlled oscillator (VCO) 320 is an oscillator that controls an oscillation frequency used for transmission and reception by a control voltage. The power amplifier (PA) 330 amplifies the power of a transmission signal by the oscillation frequency of the voltage controlled oscillator 320 and transmits the signal through the transmission antenna 341.

The low noise amplifier (LNA) 350 is an amplifier that amplifies a signal in a high frequency region received by the reception antenna 342. The frequency mixer 360 is a mixer that converts the carrier frequency of an output signal of the low noise amplifier 350 into a lower intermediate frequency by mixing the oscillation frequency of the voltage controlled oscillator 320. The intermediate frequency (IF) amplifier 370 is an amplifier that amplifies a signal converted to an intermediate frequency by the frequency mixer 360. The analog-to-digital converter (ADC) 380 converts an output of the intermediate frequency amplifier 370 from an analog signal to a digital signal. The FFT (Fast Fourier Transform) processing unit 390 performs a fast Fourier transform (FFT) processing on an output of the analog-to-digital converter 380 to extract a necessary signal.

### [Antenna]

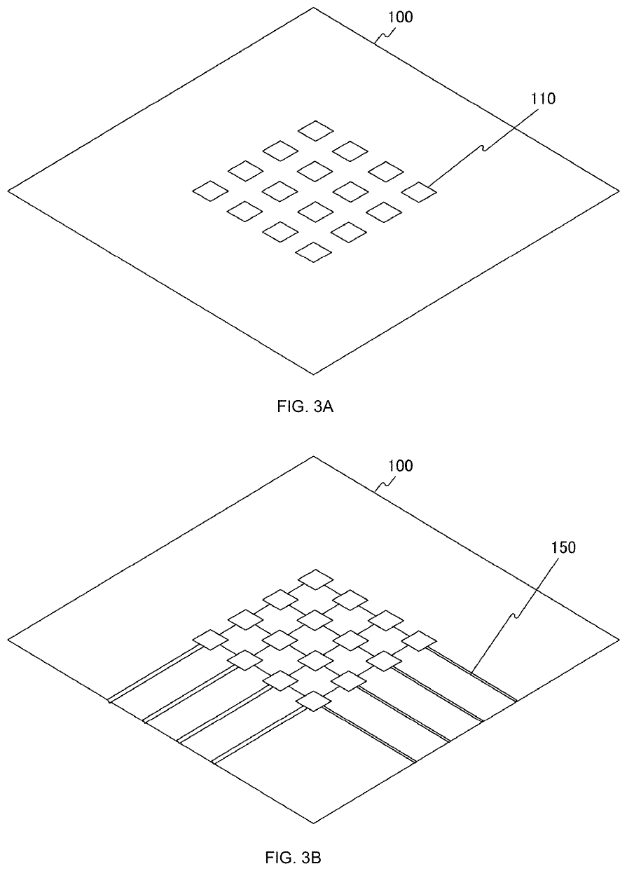

FIG. 3 is a diagram illustrating an example of a structure of the antenna 100 in the first embodiment of the present technology.

The antenna 100 includes a multilayer substrate. In the diagram, a represents an uppermost layer of the antenna 100. In the diagram, b represents a second layer and below. The antenna elements 110 are arranged two-dimensionally on the uppermost layer. Each of the antenna elements 110 is achieved by, for example, a patch antenna. On the uppermost layer, each of the antenna elements 110 is insulated from each other by a resin that is a material of a multilayer substrate. Therefore, when power is not supplied, each of the antenna elements 110 is in a floating state.

Then, the vertical feeder line 150 is formed in the second layer, and the horizontal feeder line 150 is formed in a third layer. These feeder lines 150 are formed by, for example, a microstrip line (MSL). These feeder lines 150 are also insulated from each other by the resin that is the material of the multilayer substrate in each layer. Furthermore, in each layer, one ends of the feeder lines 150 are open ends.

A ground (GND) is formed on an entire surface of a fourth layer, which is a lowest layer, and functions as a grounding plate for the feeder lines 150 of the second and third layers.

In such a structure, the antenna elements 110 and the feeder lines 150 are coupled by electromagnetic field coupling. That is, when power is fed to the feeder lines 150, the feeder lines 150 are coupled to the antenna elements 110 arranged on the upper layer thereof via an electromagnetic field.

### [Characteristics]

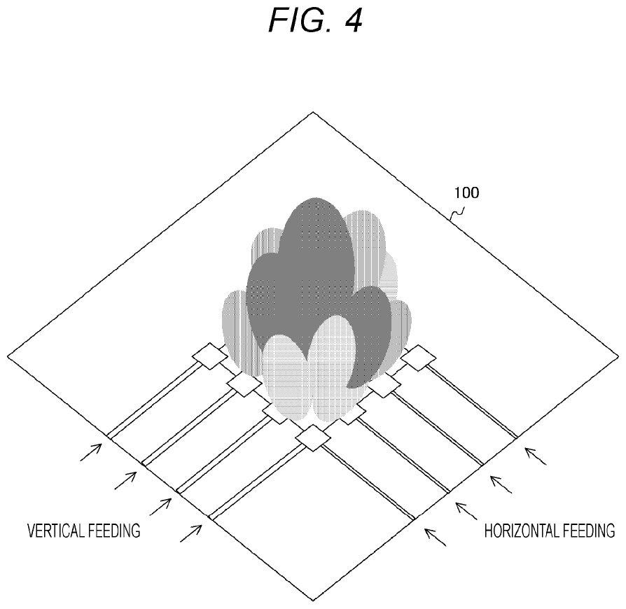

FIG. 4 is a diagram illustrating an example of feeding directions of the antenna 100 in the first embodiment of the present technology.

As described above, the antenna 100 is provided with the feeder lines 150 in two directions, and power can be fed from each of them. In the following, terms “vertical feeding” and “horizontal feeding” will be used when describing characteristics thereof, as illustrated in the diagram.

By employing the two-dimensional antenna array, the antenna 100 has characteristics of a three-dimensional radiation pattern as illustrated below for either vertical feeding or horizontal feeding. Note that as described above, in the first embodiment, it is assumed that the four phase shifters 200 feed power with the same phases.

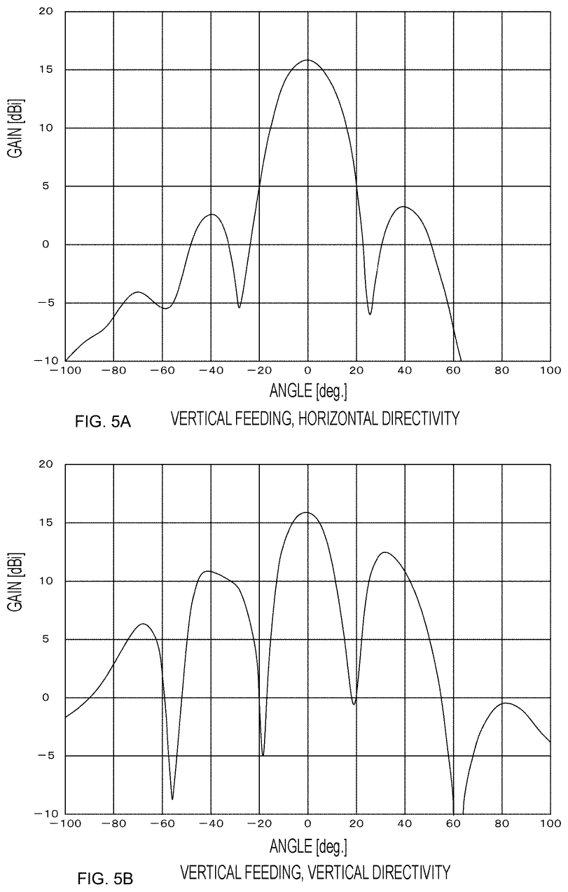

FIG. 5 is a diagram illustrating an example of characteristics of the antenna 100 by the vertical feeding in the first embodiment of the present technology. Note that the characteristics illustrated below are obtained by numerical simulation.

In the diagram, a denotes a graph illustrating directivity in a horizontal direction, that is, the direction of an azimuth angle (azimuth). Specifically, it is a diagram in which a radiation pattern is captured by a cross section taken along a plane perpendicular to the vertical direction, which is a feeding direction, at a center position of the two-dimensional antenna array. In the graph below, the horizontal axis represents a beam sweep angle (degrees), and the vertical axis represents gain (dBi) that is antenna gain. In this graph, it can be seen that a gain peak is present at zero angle, and side lobes appear around the peak.

In the diagram, b denotes a graph illustrating directivity in a vertical direction, that is, the direction of an elevation angle (elevation). Specifically, it is a diagram in which the radiation pattern is captured by a cross section taken along a plane parallel to the vertical direction, which is a feeding direction, at a center position of the two-dimensional antenna array. In this graph, it can be seen that a gain peak is present at zero angle, and more side lobes appear around the peak than in the case of the horizontal direction.

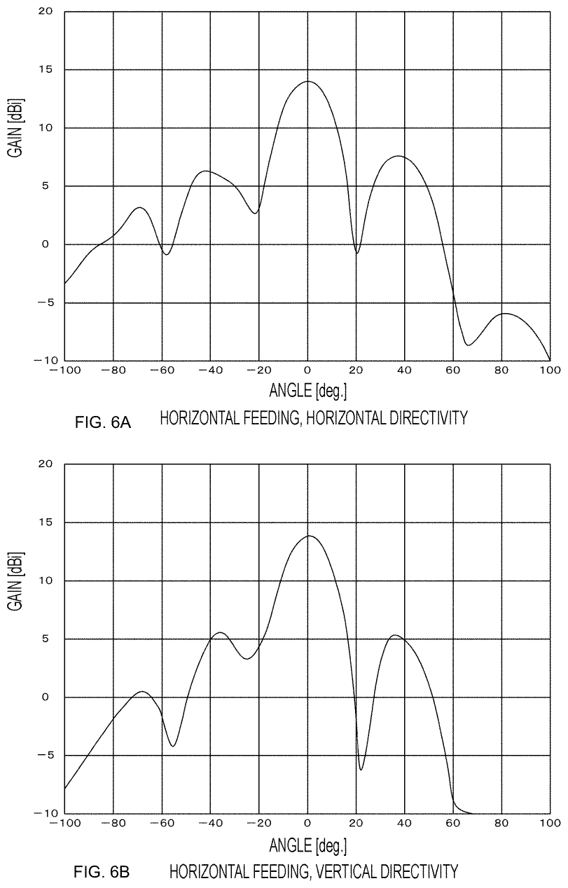

FIG. 6 is a diagram illustrating an example of characteristics of the antenna 100 by the horizontal feeding in the first embodiment of the present technology.

In the diagram, a denotes a graph illustrating directivity in the horizontal direction. Specifically, it is a diagram in which a radiation pattern is captured by a cross section taken along a plane parallel to the horizontal direction, which is a feeding direction, at a center position of the two-dimensional antenna array.

In the diagram, b denotes a graph illustrating directivity in the vertical direction. Specifically, it is a diagram in which the radiation pattern is captured by a cross section taken along a plane perpendicular to the horizontal direction, which is a feeding direction, at the center position of the two-dimensional antenna array.

It can be seen that even in these horizontal feedings, a gain peak is present at zero angle, and side lobes appear around the peak.

As described above, according to the first embodiment of the present technology, the feeder lines 150 in different directions are provided and coupled to the antenna elements 110 by electromagnetic field coupling to switch between the vertical direction and the horizontal direction to feed power, and thereby the resolutions can be improved in the both directions.

### 2. Second Embodiment

In the first embodiment described above, it is assumed that the four phase shifters 200 feed power with the same phases. On the other hand, in this second embodiment, the angle of beam sweeping is changed by shifting phases from each other. Note that the device configuration is similar to that of the first embodiment described above, and thus detailed description thereof will be omitted.

### [Phase]

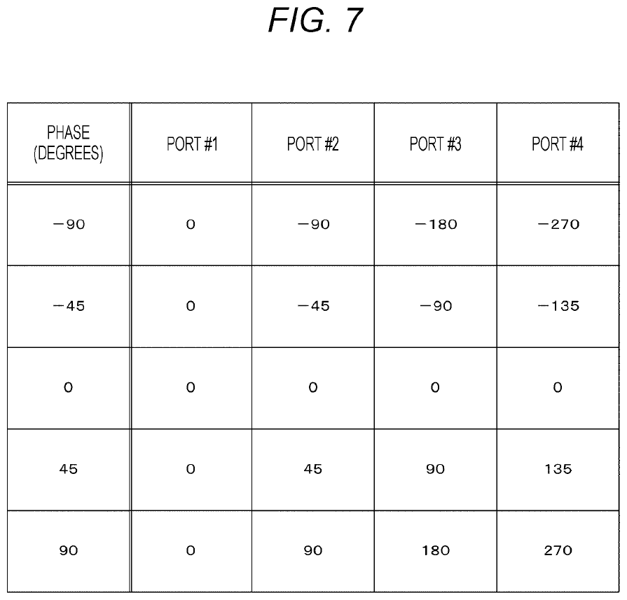

FIG. 7 is a diagram illustrating an example of phases of respective ports of feeder lines 150 in the second embodiment of the present technology.

As described above, each of the feeder lines 150 is provided with four feed lines, and four independent phase shifters 200 are connected via switching units 250, respectively. In this second embodiment, the phases are adjusted by the four phase shifters 200, and power is fed with different phases to the four feed lines. Note that in the diagram, open ends of the four feed lines of the feeder lines 150 are referred to as ports #1 to #4 in order.

As illustrated in the diagram, power is fed to port #1 with the same phase as that of feeding from a communication apparatus 300. Then, with reference to the phase of the port #1, power is fed to the ports #2 to #4 with phases being shifted. Therefore, feedings at ports #1 to #4 are shifted in phase with each other.

The following characteristics can be obtained by performing such phase-shifted feeding in each of the vertical feeding and the horizontal feeding.

### [Characteristics]

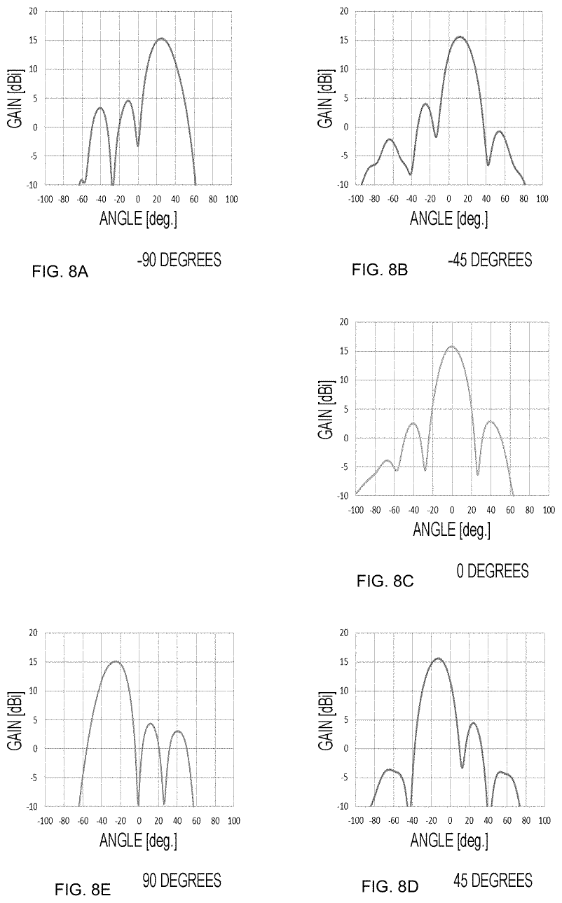

FIG. 8 is a diagram illustrating an example of characteristics of the antenna 100 by the vertical feeding in the second embodiment of the present technology.

The diagram includes graphs illustrating directivity in the horizontal direction, that is, in the direction of an azimuth angle. In the diagram, a denotes a graph illustrating directivity of a phase of “−90 degrees”, b denotes that of a phase of “−45 degrees”, c denotes that of a phase of “0 degrees”, d denotes that of a phase of “45 degrees”, and e denotes that of a phase of “90 degrees”. Accordingly, it can be seen that by shifting the phase of the vertical feeding, beam scanning can be performed by swinging the directivity in the horizontal direction, which is a plane perpendicular to the feeding direction.

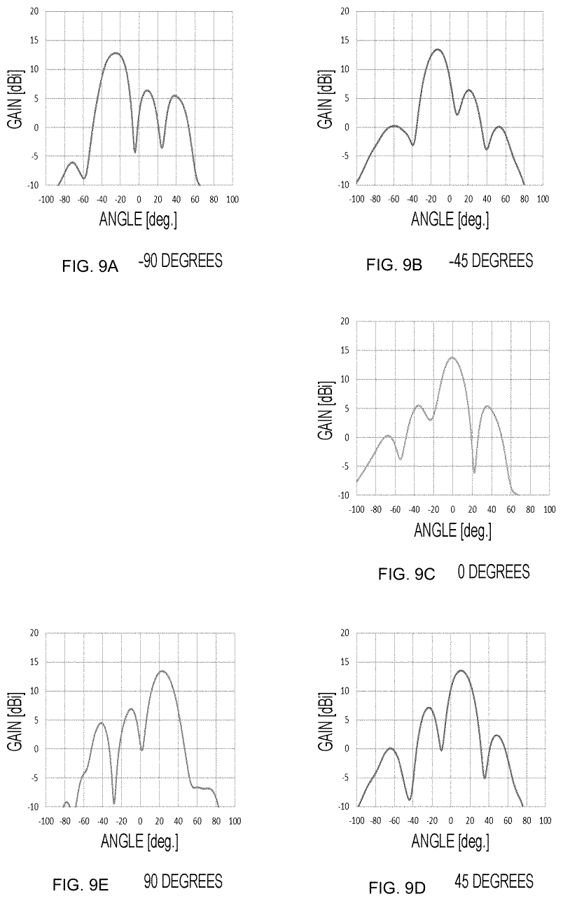

FIG. 9 is a diagram illustrating an example of characteristics of the antenna 100 by the horizontal feeding in the second embodiment of the present technology.

The diagram includes graphs illustrating directivity in the vertical direction, that is, the direction of an elevation angle. In the diagram, a denotes a graph illustrating directivity of a phase of “−90 degrees”, b denotes that of a phase of “−45 degrees”, c denotes that of a phase of “0 degrees”, d denotes that of a phase of “45 degrees”, and e denotes that of a phase of “90 degrees”. Accordingly, it can be seen that by shifting the phase of the horizontal feeding, the beam scanning can be performed by swinging the directivity in the vertical direction, which is a plane perpendicular to the feeding direction.

As described above, according to the second embodiment of the present technology, by feeding power by shifting the phases of the different feed lines in the feeder lines in the same feeding direction, beam scanning can be performed by swinging the directivity in the direction of the surface perpendicular to the feeding direction without moving the antenna 100 itself.

### 3. Third Embodiment

In the second embodiment described above, the beam scanning can be performed in one-dimensional direction for each of the elevation angle and the azimuth angle, but the beam scanning cannot be performed in any two-dimensional direction. Therefore, in a case where a plurality of objects is detected with each of the elevation angle and the azimuth angle, it may happen that the positions of the individual objects cannot be grasped only by the information. Therefore, in the third embodiment, the position of a flat surface is determined by further combining distance information and speed information by a radar.

### [Configuration]

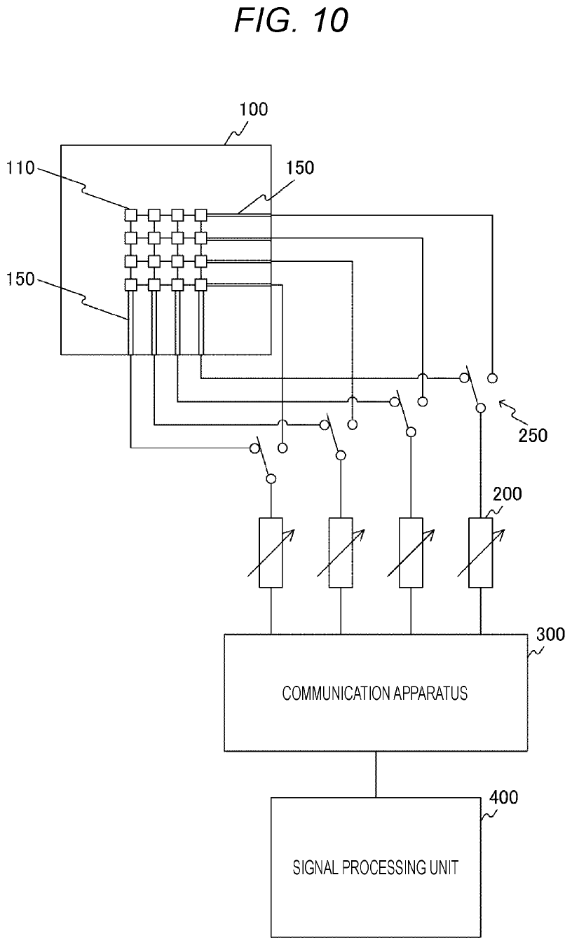

FIG. 10 is a diagram illustrating an example of an overall configuration of a radar system in the third embodiment of the present technology.

This radar system includes an antenna 100, a phase shifter 200, a switching unit 250, and a communication apparatus 300, and further includes a signal processing unit 400, as in the first embodiment described above.

The signal processing unit 400 determines the position of an object by combining information obtained as the radar system. That is, the signal processing unit 400 determines the position of a flat surface of each object by combining position information in the elevation angle and the azimuth angle obtained by performing beam scanning by shifting the phase of feeding according to the second embodiment described above, and the distance information and the speed information by the radar.

### [Position Determination]

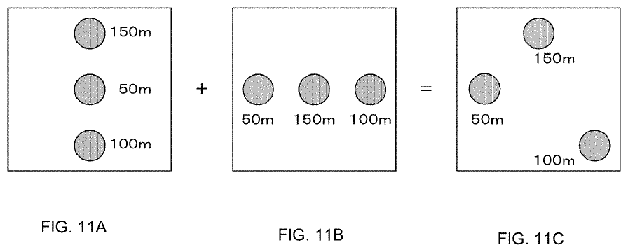

FIG. 11 is a diagram illustrating a specific example of determining a position of an object in the third embodiment of the present technology.

In the diagram, a denotes an example in which three objects are detected by performing beam scanning in the vertical direction by horizontal feeding. At this time, as the distance information acquired by the radar, the values of “150 m”, “50 m”, and “100 m” from the above object are illustrated.

In the diagram, b denotes an example in which three objects are detected by performing beam scanning in the horizontal direction by vertical feeding. At this time, as the distance information acquired by the radar, the values of “100 m”, “150 m”, and “50 m” are illustrated from the object on the right.

By combining the vertical and horizontal positions obtained by beam scanning with the distance information acquired by the radar, the position of the flat surface of each object can be specified as illustrated in c in the diagram. If only the positions obtained by the beam scanning are used, the correspondence between an object detected by the vertical beam scan and an object detected by the horizontal beam scan becomes unclear, and it becomes impossible to specify the position of the flat surface of each object.

As described above, according to the third embodiment of the present technology, the position of a flat surface of each object can be determined by combining the position information of the elevation angle and the azimuth angle obtained by beam scanning with the distance information by the radar or the like.

### 4. Fourth Embodiment

In the above-described embodiment, it is assumed that the switching unit 250 switches to either the vertical direction or the horizontal direction to feed power, but in a fourth embodiment, feedings are performed simultaneously from the vertical direction and the horizontal direction.

### [Configuration]

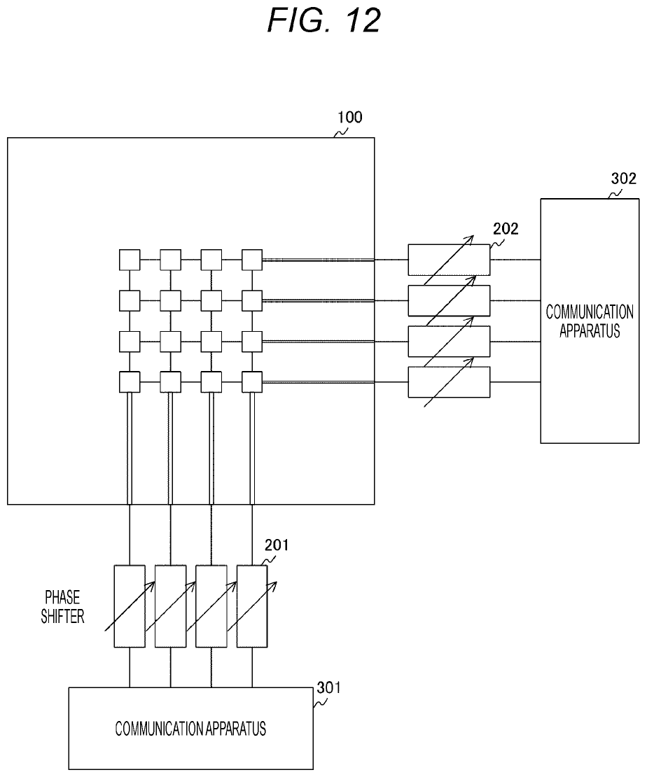

FIG. 12 is a diagram illustrating an example of an overall configuration of a radar system in the fourth embodiment of the present technology.

The radar system includes an antenna 100, phase shifters 201 and 202, and communication apparatuses 301 and 302. Specifically, simultaneous power feedings are enabled by independently providing the phase shifter 201 for feeding power in the vertical direction and the phase shifter 202 for feeding power in the horizontal direction. Thus, the vertical and horizontal beams can be emitted simultaneously in this example.

In this case, polarizations of the vertical beam and the horizontal beam are orthogonal to each other and isolation of the feeder lines 150 is ensured, and thus they do not interfere with each other even if simultaneous feedings are performed in the vertical and horizontal directions.

As described above, according to the fourth embodiment of the present technology, the vertical beam and the horizontal beam can be emitted at the same time by performing simultaneous feedings in the vertical direction and the horizontal direction.

### 5. Fifth Embodiment

In the above-described embodiment, a quadrangle is assumed as the shapes of the antenna elements 110 of the antenna 100, but other shapes may be employed.

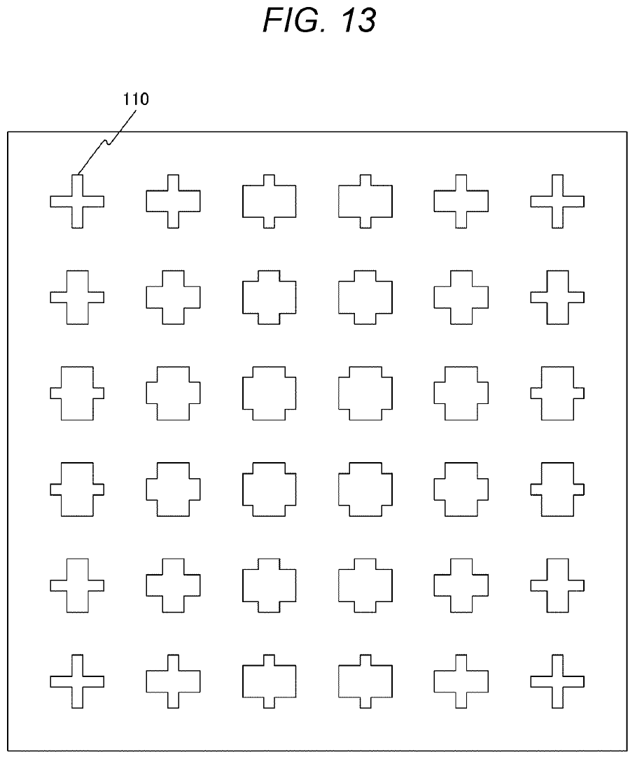

FIG. 13 is a diagram illustrating a first shape example of an antenna 100 in a fifth embodiment of the present technology.

In this example, a cross shape is employed in consideration of feedings from two orthogonal directions. That is, among the antenna elements 110 arranged in the feeding directions, the widths of antenna elements on both ends are narrower, and the widths of antenna elements arranged on a center side are wider.

Thus, the power fed to one antenna element 110 can be adjusted, and side lobes of the emitted beam can be reduced. A side lobe is a beam other than a main lobe, which has the highest radiation level. If the level of the side lobe is high, it becomes difficult to separate it from the main lobe, and a signal noise ratio (SN) deteriorates, which may lead to false detection of an object. In this regard, by making the widths of the antenna elements narrower toward both ends, the side lobes can be reduced and erroneous detection of an object can be avoided.

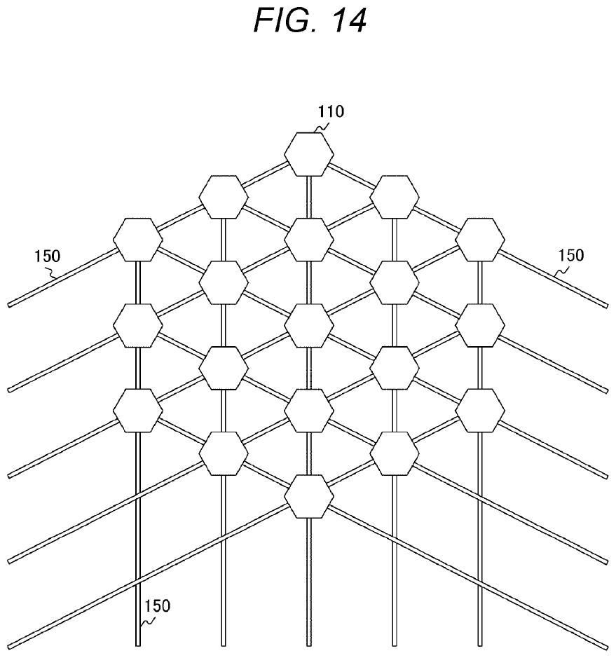

FIG. 14 is a diagram illustrating a second shape example of the antenna 100 in the fifth embodiment of the present technology.

In this example, in order to feed power from three directions, the angle formed by the feeder lines 150 is assumed to be 60 degrees, and a hexagon is employed as the shapes of the antenna elements 110. That is, it is a polygon having sides orthogonal to the feeder lines 150.

In this case, the isolation between the feeder lines 150 is disadvantageous as compared with cases of two orthogonal directions, but there is an advantage that the resolution is improved and the two-dimensional mapping becomes easy.

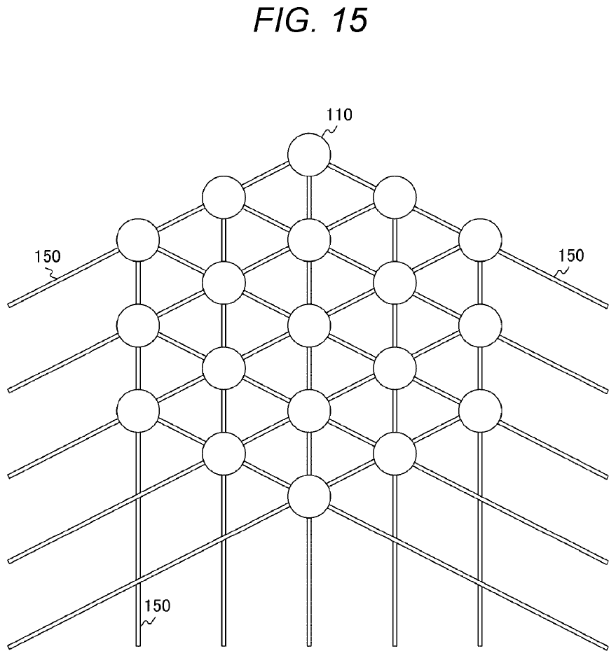

FIG. 15 is a diagram illustrating a third shape example of the antenna 100 in the fifth embodiment of the present technology.

In this example, a circular shape is employed as the shapes of the antenna elements 110. In this case, the feeder lines 150 may or may not be orthogonal to each other. That is, there is an advantage that the degree of freedom of two-dimensional mapping is improved.

Thus, as described in the fifth embodiment of the present technology, various shapes can be employed as the shapes of the antenna elements 110 in consideration of the angle formed by the feeder lines 150.

### 6. Sixth Embodiment

In the first to fourth embodiments described above, it is assumed that the sixteen antenna elements 110 are arranged in an array. On the other hand, in a sixth embodiment, an arrangement structure in which antenna elements 110 are shifted is provided.

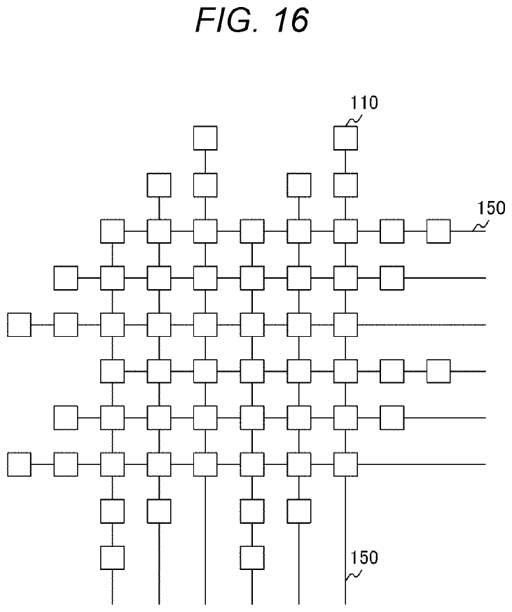

FIG. 16 is a diagram illustrating an arrangement example of the antenna elements 110 of an antenna 100 in the sixth embodiment of the present technology.

This example is similar to the above-described first to fourth embodiments in that feedings are performed from the vertical direction and the horizontal direction. However, the antenna element groups, which are sets of antenna elements 110 arranged in the feeding directions, are arranged so as to be offset in the feeding directions. That is, the adjacent antenna element groups are arranged at different positions in the feeding directions.

In one antenna element group, by arranging the antenna elements 110 in one direction, the resolution is increased and the directivity is strengthened. Then, by arranging the antenna element groups in a shifted manner, similar effects to those of swinging the beam in the same direction and shifting the center positions of feedings can be obtained. In this example, since the antenna elements 110 are arranged so as to be shifted in the vertical direction and the horizontal direction, it is possible to swing the beam in both directions.

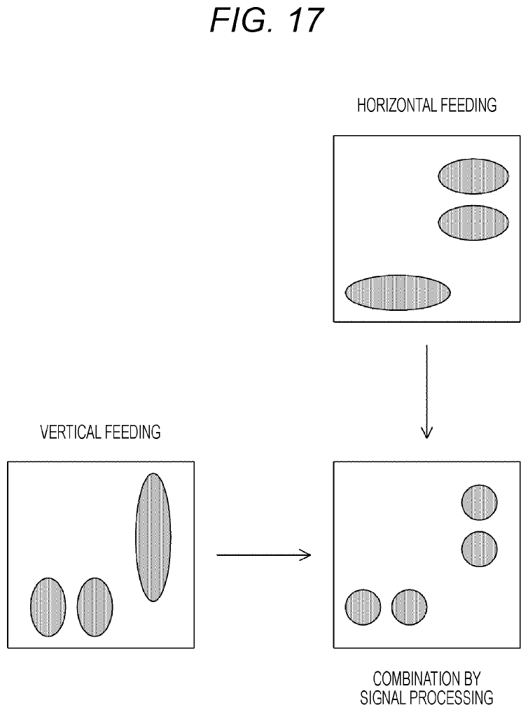

FIG. 17 is a diagram illustrating an example of object detection in the sixth embodiment of the present technology.

In the sixth embodiment, as described above, since the antenna elements 110 are arranged so as to be displaced in the vertical direction and the horizontal direction, the beam can be swung in both directions. At this time, with respect to the vertical feeding, the horizontal resolution is high, but the vertical resolution is low. On the other hand, with respect to the horizontal feeding, the vertical resolution is high, but the horizontal resolution is low. Thus, as illustrated in the diagram, in the vertical feeding, there may be a case where it is difficult to separate and detect each of independent objects existing in the vertical direction. Furthermore, in the horizontal feeding, there may be a case where it is difficult to separate and detect each of independent objects existing in the horizontal direction.

Accordingly, as in the third embodiment described above, the signal processing unit 400 is assumed, and a detection result by the vertical feeding and a detection result by the horizontal feeding are combined by signal processing. Thus, it becomes possible to separate and detect an object that has not been possible to be separated by feeding in only one direction.

As described above, according to the sixth embodiment of the present technology, by arranging the antenna elements 110 by shifting them in the vertical direction and the horizontal direction, beam scanning can be performed by swinging the directivity in each direction without moving the antenna 100 itself. Furthermore, by combining the results in both directions by signal processing, it is possible to separate and detect an object that has not been possible to be separated by feeding in only one direction.

Note that the embodiment described above illustrates an example for embodying the present technology, and matters in the embodiment and matters specifying the invention in the claims have respective correspondence relationships. Similarly, the matters specifying the invention in the claims and matters having the same names in the embodiment of the present technology have respective correspondence relationships. However, the present technology is not limited to the embodiment and can be embodied by making various modifications to the embodiment without departing from the gist thereof.

Note that effects described in the present description are merely examples and are not limited, and other effects may be provided.

Note that the present technology can have configurations as follows.

(1) An antenna device including:

a plurality of antenna elements arranged in a two-dimensional plane; and

first and second feeder lines that feed power to the plurality of antenna elements from first and second directions different from each other.

(2) The antenna device according to (1) above, in which

the plurality of antenna elements and the first and second feeder lines are coupled by electromagnetic field coupling.

(3) The antenna device according to (1) or (2) above, further including

a switching unit that switches a signal to at least one of the first or second feeder lines.

(4) The antenna device according to any one of (1) to (3) above, in which

the first and second feeder lines each include a plurality of feed lines.

(5) The antenna device according to (4) above, further including

a phase shifter that controls phases of signals of the plurality of feed lines.

(6) The antenna device according to (5) above, in which the phase shifter controls the phases of the signals of the plurality of feed lines to be all same.

(7) The antenna device according to (5) above, in which the phase shifter controls the phases of the signals of the plurality of feed lines to be different from each other.

(8) The antenna device according to any one of (1) to (7) above, in which

the first and second feeder lines are orthogonal to each other.

(9) The antenna device according to any one of (1) to (7) above, in which

the first and second feeder lines are not orthogonal to each other.

(10) The antenna device according to any one of (1) to (9) above, in which

a shape of each of the plurality of antenna elements is a polygon having sides orthogonal to the first and second feeder lines.

(11) The antenna device according to any one of (1) to (9) above, in which

a shape of each of the plurality of antenna elements is a circular shape.

(12) The antenna device according to any one of (1) to (11) above, in which

the plurality of antenna elements includes a plurality of antenna element groups arranged in a feeding direction, and

in the plurality of antenna element groups, a width of an antenna element arranged on a center side is wider than widths of antenna elements arranged on both end sides in the feeding direction.

(13) The antenna device according to any one of (1) to (12) above, in which

a shape of each of the plurality of antenna elements is a cross shape.

(14) The antenna device according to any one of (1) to (13) above, in which

the plurality of antenna elements includes a plurality of antenna element groups arranged in a feeding direction, and

adjacent antenna element groups among the plurality of antenna element groups are arranged at different positions from each other in the feeding direction.

(15) A radar system including:

a plurality of antenna devices each including a plurality of antenna elements arranged in a two-dimensional plane, and first and second feeder lines that feed power to the plurality of antenna elements from first and second directions different from each other and that each include a plurality of feed lines;

a plurality of phase shifters connected to at least one of the first or second feeder lines for each of the plurality of antenna devices to control phases of signals of the plurality of feed lines; and

a communication unit that performs transmission via one of the plurality of phase shifters and reception via another of the plurality of phase shifters to acquire information regarding an object.

(16) The radar system according to (15) above, further including

a plurality of switching units that switches, for each of the plurality of antenna devices, between the phase shifters and at least one of the first or second feeder lines,

in which the plurality of switching units performs same switchings in synchronization with each other.

(17) The radar system according to (15) above, further including a signal processing unit that combines the acquired information to generate a position of the object.

### REFERENCE SIGNS LIST

100 Antenna
110 Antenna element
150 Feeder line
200 to 202 Phase shifter
250 Switching unit
300 to 302 Communication apparatus
310 Modulated signal generator
320 Voltage controlled oscillator
330 Power amplifier
341 Transmission antenna
342 Reception antenna
350 Low noise amplifier
360 Frequency mixer
370 Intermediate frequency amplifier
380 Analog-to-digital converter
390 FFT processing unit
400 Signal processing unit

1. An antenna device comprising:
a plurality of antenna elements arranged in a two-dimensional plane; and
first and second feeder lines that feed power to the plurality of antenna elements from first and second directions different from each other.

2. The antenna device according to claim 1, wherein
the plurality of antenna elements and the first and second feeder lines are coupled by electromagnetic field coupling.

3. The antenna device according to claim 1, further comprising
a switching unit that switches a signal to at least one of the first or second feeder lines.

4. The antenna device according to claim 1, wherein
the first and second feeder lines each include a plurality of feed lines.

5. The antenna device according to claim 4, further comprising
a phase shifter that controls phases of signals of the plurality of feed lines.

6. The antenna device according to claim 5, wherein
the phase shifter causes the phases of the signals of the plurality of feed lines to be all same.

7. The antenna device according to claim 5, wherein
the phase shifter causes the phases of the signals of the plurality of feed lines to be different from each other.

8. The antenna device according to claim 1, wherein
the first and second feeder lines are orthogonal to each other.

9. The antenna device according to claim 1, wherein
the first and second feeder lines are not orthogonal to each other.

10. The antenna device according to claim 1, wherein
a shape of each of the plurality of antenna elements is a polygon having sides orthogonal to the first and second feeder lines.

11. The antenna device according to claim 1, wherein
a shape of each of the plurality of antenna elements is a circular shape.

12. The antenna device according to claim 1, wherein
the plurality of antenna elements includes a plurality of antenna element groups arranged in a feeding direction, and
in the plurality of antenna element groups, a width of an antenna element arranged on a center side is wider than widths of antenna elements arranged on both end sides in the feeding direction.

13. The antenna device according to claim 12, wherein
a shape of each of the plurality of antenna elements is a cross shape.

14. The antenna device according to claim 1, wherein
the plurality of antenna elements includes a plurality of antenna element groups arranged in a feeding direction; and
adjacent antenna element groups among the plurality of antenna element groups are arranged at different positions from each other in the feeding direction.

15. A radar system comprising:
a plurality of antenna devices each including a plurality of antenna elements arranged in a two-dimensional plane, and first and second feeder lines that feed power to the plurality of antenna elements from first and second directions different from each other and that each include a plurality of feed lines;
a plurality of phase shifters connected to at least one of the first or second feeder lines for each of the plurality of antenna devices to control phases of signals of the plurality of feed lines; and
a communication unit that performs transmission via one of the plurality of phase shifters and reception via another of the plurality of phase shifters to acquire information regarding an object.

16. The radar system according to claim 15, further comprising
a plurality of switching units that switches, for each of the plurality of antenna devices, between the phase shifters and at least one of the first or second feeder lines,
wherein the plurality of switching units performs same switchings in synchronization with each other.

17. The radar system according to claim 15, further comprising a signal processing unit that combines the acquired information to generate a position of the object.
